(19) United States
(12) Patent Application Publication
(10) Pub. No.: US 2022/0138847 A1
(43) Pub. Date: May 5, 2022

(54) Multi-Faceted Trading Education

(71) Applicant: Trade Support, Lehi, UT (US)

(72) Inventors: Kevin Charles Jones, Salem, UT (US); Matthew Edward Poll, Bluffdale, UT (US)

(73) Assignees: Kevin Charles Jones, Salem, UT (US); Matthew Edward Poll, Bluffdale, UT (US)

(21) Appl. No.: 17/086,401

(22) Filed: Oct. 31, 2020

(51) Int. Cl. G06Q 40/04; G06Q 50/20; G06Q 50/00; G06Q 30/00; G06Q 40/02

(52) U.S. Cl. CPC G06Q 40/04; G06Q 50/205; H04L 51/046; G06Q 30/018; G06Q 40/02; G06Q 50/01

(57) ABSTRACT

Mentioning investing or trading, herein referred to as trading, in the general populous engenders common expressions related to financial risk, selective success, skepticism, and avoidance. Such reactions are not without justification. Despite increasingly available financial market access as well as improving trading technology and techniques for access to the financial markets, an individual's success is often marginal. Trading involves appropriate market choice for the participant, overall or fundamental event and market awareness, specific asset or technical analysis, aid and indicator choices and techniques, the type of training obtained, the amount of experience based on practice and live market participation, and attributes around the temperament and discipline of a participant. Participation in the market is multi-faceted and provides reasons that general success could be marginal. Disclosed herein is an innovative Multi-Faceted Trading Educational system and process to address the many aspects required for successful financial market participation.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### COPYRIGHT STATEMENT

All written and graphic representation in this patent document are subject to copyright protection under the copyright laws of the United States and other countries. The copyright owner has no objection to the reproduction of a patent, patent application, or invention disclosure if retained as a complete document as published by the copyright owner, government, or found in a government record. Otherwise all other copyright provisions whatsoever are reserved.

### BACKGROUND OF THE INVENTION

### Field of the Invention

This invention generally involves the use of financial market data, aids and indicators for market data interpretation, and a Multi-Faceted Trading Education to achieve an improved financial market participation outcome.

### PROBLEM STATEMENT

Investing or trading, or generally “trading” in the financial markets relies upon doing so in the anticipated direction of increased instrument value in the market. The term financial market is ascribed to any activity formally organized to exchange ownership, responsibility, or value of an instrument by way of use of monetary exchange. Monetary exchange being different from that of deriving value from material, labor, land, bartering, or other form of value exchange. A financial market instruments today commonly takes the form of equities or stocks, bonds and other sovereign government promissory notes, currency pair comparative value, agricultural or mineral yields, derivatives thereof, and so on.

Markets establish policies that represent tangibles or agreed value creation that requires administration of the exchange among participants. Given common interest in various instruments, both a location and facilitators of exchange were needed. Initially this took the form of an agreed upon location in a community and eventually to a specific location dedicated to that instrument, called a trading floor. Consider this organizational structure infrastructure as forming the market. Facilitators of exchange on that floor became known as brokers acting on behalf of others near and far to the consolidated location of exchange for a particular instrument. Much of our terminology and practices have emerged from this period of concentrated instrument location trading. With modern information technology, physical trade locations for an instrument have largely dissolved and moved to a virtual online location. This became an environment of dispersed infrastructure by way of software, servers, computers, devices, internet and intranet connectivity and other information technology from the market to brokers to the local user and their combinations With this infrastructure connectivity, Brokers have largely moved online and remain integral as consolidators of activity with a financial instrument.

Important to realize is that financial markets are derived from the outlook and perspective of individuals acting in their own best self-interest or in the best self-interest of an organization. Given the myriad of individual and organization participants and their best self-interest circumstances, market knowledge, experience, available assets, and so forth; the outlook of a market conditions is seen differently. Combine this with external economic, competitive, personnel, country, regional, and other factors there are substantial and varied forces acting upon market by participants and therefore ultimately a somewhat unknown market behavior. As such, anticipating the direction of the aggregate value of an instrument in the market is unpredictable and uncertain given the many and various forces and perspectives upon the market.

Attempts at ascertaining a somewhat random market behavior of an instrument has taken on various forms. These have largely been categorized as fundamental analysis or technical analysis. Fundamental analysis involves the use of market external news and information to assess potential general market or instrument specific influences that may affect coming behavior. Technical analysis attempts the use market data and parameters to ascertain future market direction. With technical analysis, many take the approach of assessing historical and current market price information. Such an approach is generally known as price action participation. Others look towards the use of mathematical manipulation of various forms and sources of historical and current market data. These mathematical approaches to analysis can be referred to as indicators.

Ultimately through the many decades of participating in the market from its most informal origins to its current mature experience, extensive use of mathematics, and information technology-based format, the outcomes of market participation success can still be mixed. An active search for informed and executed trade science or skill has been sought. Disclosed is an innovative Multi-Faceted Trading Education system and process to achieve an improved trading outcome.

### STATE OF THE ART ASSESSMENT

Participating in financial markets is now widely available beyond institutions and the well-resourced to essentially all individuals. As broad as the variances in individuals, this is a likeness of the variance in readiness of individuals to participate in the markets. In part this is due to a lack of access points to a trading education.

The most ideal entrance into the market occurs with formally educated individuals that then work professionally with a firm or individual with years of experience, systems, tools, and tips as to how to best participate in a given market. Undoubtedly, a relevant formal education combined with on-the-job training, certification, tutoring, mentoring, apprenticeship, and other guided education and experience is likely to create an informed, capable, and likely more successful market participate in an institutional role or as an individual. Expectedly, the number of individuals with such a career or professional intention followed by successful participation institutionally are comparatively small.

Most individuals seeking to participate in the financial markets do so from largely an experimental starting point. They may have picked up some ideas here and there and then open an account, fund it with a few discretionary dollars, and experiment in the market. Of course, part of this individual attempt at trading for many involves some education. Today, likely most of that is through video, online content, books, and so forth. Many that seek this route for financial market participation do so to avoid the costs of paid education programs. However, it is not unusual that this self-taught approach can be have its own costs in lost revenue due to the long time to learn to participate in the markets and often from the high costs of many or bigger mistakes in the markets. History shows that despite these laudable efforts that there still remains something missing for these self-taught traders. For the vast number of these individuals, their success is limited and often leads to losses or discomfort with the market and their elimination from participation. This is unfortunate as it is for this reason that a many are not as successful as they wish to be in the markets and ultimately word gets out that trading is risky, only a few are successful, and such.

Other more fortunate individuals may have access to others that have made the leap into successful market participation by one way or another. For most of these individuals their initial thoughts are they have a path to successful market participation. What most find is that traders are not as accessible for mentorship as they expected, even with close relationships. Traders are busy trading. Trade training takes time and effort over an extended period. Although not an accurate and realistic thought, as the more participants there are in the markets the better the financial markets become, some trading mentors may not want to share their trading techniques. Further, new financial market participants need to realize that approaching a known successful market participant, that they will be receiving just one perspective towards the market, all be it successful for that person. As a whole, even though one may know of a successful participant in the market, that is not often as sure a way into successful market participation as expected.

The challenge still remains, how do most people gain entry into the financial markets as a trader. Again, most will not have the benefit of related formal education and work experience, self-study is proven time consuming and unreliable, and access to known successful market participants has shown them to be less accessible than would be expected. What is left is the use of paid private individual or institutional instructions. Many market participant hopefuls are reluctant to want to pay for such services, but many do ultimately realize this may be their most timely and reliable access to market participation. The type and quality of such programs does vary, as expected. Many of these are individual market participants that train other as an aspect of leveraging their knowledge and experience in trading. Although they provide access, they still only provide one perspective towards market participation. Further, as one individual there still may remain limited access to trainers with more proven market success. This limitation shows up in many forms as there is only so much that an individual trainer can accomplish as far as offering individual attention, video content, regular webinars, and so forth. Other offerings may be from institutions that broaden financial market perspective to various trainers, if such access is programed or granted. Whether an individual or institutional financial market trading education, many of these are influenced by profit making forces. This likely shows up first in having more than one student being instructed at a time, possible limits on instruction duration and access, and so on.

Disclosed herein is the Applicant's Multi-Faceted Trading Education that recognized the limitations of trading information access and provides a system to address the shortfalls common to the participation in the financial markets as discussed. The Applicant uniquely combines aspects of self-study with training and trading elements, individualized coaching with training and trading instruction and activity, group training and trading education, event and webinar training and trading, group participation through events and a device based chat application, and more. Important to this innovative system is both participant and group assessments of the participants development for successful participation in the financial markets as a trader. The participant continues to participate in aspects of the Applicant's Multi-Faceted Trading Education until such time as the participant through self-assessment and with information of group assessments the participant is able to determine their readiness for financial market trading participation. This is an accessible approach with the benefits of both individualized and group contribution for a surprisingly effective participant trading outcome in the financial markets. An outcome that shows improved trading outcomes beyond that of typical trading outcomes.

### BRIEF SUMMARY OF THE INVENTION

The Applicant discloses an effective Multi-Faceted Trading Education system and process that creates surprisingly effective trading participation in the financial markets whether the participant had previous trading experience or no previous trading experience.

This innovation takes readily available market infrastructure of software, servers, computers, connectivity, and other information technology from the market to the local user to also include data, and interface portals through brokerage firms and data manipulation services to uniquely participate in the financial markets. First a financial market is chosen and an appropriate brokerage firm is selected to interface in the market. The Applicant uniquely assesses market data by way of its proprietary mathematical algorithms to manipulate market data for unique signals suggesting anticipated market behavior. The Applicant's mathematical algorithms are provided to a data manipulation service for conversion into charted into local graphical and numeric trade signals for use by Applicant prospects, students, and group members. These signals in combination with general financial market data in the form of price movement represented by what the financial market knows as candlesticks. With general market data, unique market signals, and access to the markets the foundation of the Applicant's Multi-Faceted Trading Education system and process is resources and participants are able to uniquely access and participate in the financial markets.

The Applicants Multi-Faceted Trading Education begins with any individual being able to assess it through a Trial Trading Education And Experience. This is a full system assessment with Trial Education that includes learning the market basics, indicator and use basics, analysis software basics, trade placement basics. With some foundational information and knowledge, a prospect assessing the Applicant's day trading system can then actually enter the financial market with a practice account for Trial Trading Experience. That can include applying the basics of trade placement in the market with a practice account using the brokers trade portal, participating in basic training onsite and online webinars, participating in basic onsite and online trading webinars, communicate with other prospects through general participation but also a basic group chat, and access to general support. The prospect simply cycles through trading education and experience until the prospect and the group assess they are ready for more formal Certified Trading Education And Training.

The Applicant's Trial Trading Education And Experience for the prospect is a realistic experience of the Applicants Multi-Faceted Trading Education system and process that the Certified Education And Experience is largely a replication of the Trial Trading Education And Experience, but with advanced topics. A prospect entering the Certified Trading Education And Experience is seen as a student accepted into the system or process. They enter and cycle through a Certified Trading Education with advanced market evaluation, advanced indicator understanding and use, advanced analysis software awareness and use, advanced trade placement portal or brokerage portal awareness and use, and advanced trade placement information and knowledge supported by the collective awareness of the Certified Trading Education. The student then applies the trading information and education received. The student cycles through the Certified Trading Experience. It includes actual advanced trade placement in the market with a practice account using the brokers trade portal. It also involves advanced onsite and online training webinars covering the markets, indicators, analysis software, brokerage portal, trade identification and assessment, and other related trade best practices. There are also advanced onsite and online advanced trading webinars where potential trades are found, assessed, and appropriate trades placed in the market. Students also continue with an advanced group chat application to communicate now on a more advanced level with other students. The students also benefit from advanced support with the system and process. The student cycles through the Certified Trading Education and Certified Trading Experience until they assess themselves ready and the group assesses them ready to trade real money in the financial market.

Described from another perspective is the revealing of the Applicant's Multi-Faceted Trading Education that creates an improved trading outcome, well beyond the typical trading outcome. It starts with 1-to-1 personal guidance through the Trial Trading Education and Trial Trading Experience. This 1-to-1 personal core instruction continues into the Certified Trading Education and Certified Trading Experience. It includes that which has been previously described herein and reframed into broader descriptors includes market information and awareness, core and advanced indicators understanding and use, market information analysis skills, and trade placement skills. It also includes trade skill improvement with actual trade placement, trade money management for proper trade account and fund utilization and protection, trade psychology to address the mental and emotional aspects of participating in the market, and consideration of the character of the trade. These same elements of the 1-to-1 personal guidance are addressed again or as multiple facets with small group instruction. The benefit is broader perspective by delivery from likely a different coach, trainer, or mentor. A broader perspective also due to the interaction and participation with other students and members. 1-to-1 personal and small group interaction can occur in person and remotely online. However, it would be immediately recognized that side-by-side in-person coaching, training, and mentoring would have several advantages. As such, another of the multiple facets for improved trading results is a side-by-side educational elements. The significance can result in a mastery level of instruction and participation in the financial markets. It includes a focus on mastery of core and advanced indicators in going beyond the science of their mechanical usage into the art of subtlety for substantial market participation advantage. Address is levels of trade mastery in trade identification, assessment, and placement. The development of a personal trade plan which adapts trading to the nature of the individual and their proclivities. As another 1-to-1 personal training opportunity there is ability to address any trade refinement specific to a student. Additionally, the Applicant's Multi-Faceted Trade Education includes Large Group Expert Event Instruction. This is an opportunity to make available to all students and members of the group the latest best practices, the most accomplished coaches and trainers, address contemporary topics of trading, as such on a regular and reoccurring basis for specific education and general review and elevation of student and member participants. The Large Group Expert Event Instruction can include expert core and advanced indicator understanding and use, expert live market trading best practices, expert trade psychology, and senior member experience sharing. Ultimately the student and members experience a Multi-Faceted Trading Education that can provide a surprisingly improved trading outcome.

The Applicant's Multi-Faceted Trading Education provides access to improved trading outcomes because it provides a layering of trading perspective that more closely mimics the layered complexity of market participation. The Applicant's Multi-Faceted Trading Education allows a prospect to assess their compatibility with a likeness of the type of trading information and knowledge that will be needed and then apply that with market participation. Another layer is the prospect becoming a student and extending further into advanced aspects of Certified Trading Education and experience. Largely, this training benefits from personalized instruction and guidance through practice trade placement in the markets. Layering on this is small group training, trading, and interaction that brings broader perspective from different contributors. Another layer is back to not just personalized training and trading, but side-by-side training and trading at a mastery level. A student now with some information and knowledge background and experience in the markets in practice and real money participation has the working background to move into refined Applicant processes and system for additional improved trading outcomes. Further beyond this layer is the large group expert event and instruction. Back to a group environment that goes beyond basics and advanced training to have someone participate in the market with improved trading outcomes, but now surrounding participants with the most relevant contemporary topics, the best expert presenters, the most proven and expert tactics and strategies in the market, greater depth in trade psychology and trade management, and more such expertise. The participant is able to gain insight and trade skill development from multiple avenues and angles and continue to cycle through any aspect of the Applicant's Multi-Faceted Trading Education to increasingly refine and expand their own expertise to achieve the level of improved trading outcomes they seek. The Applicant's Multi-Faceted Trading Education system and process is surprising effective in creating improved trading outcomes and yet is simple and accessible to all those that try it in a trial education and experience and see their ability and interest in trading the financial markets with improved trading outcomes and they experience it using the Applicants trading system and process.

### BRIEF DESCRIPTION OF THE SEVERAL VIEWS OF THE DRAWING

FIG. 1—Diagram Of Financial Markets And Multi-Faceted Trading Education Integration. The general financial market structure and disclosure interface into the market.

FIG. 2—Flow Chart Of Multi-Faceted Trading Education System. The overall perspective of the disclosed trading educational system.

FIG. 3—Flow Chart Of Trial Trading Education And Experience. A demo trial of the trading education system allows clients to experience trading and the uniqueness of the disclosed system

FIG. 4—Flow Chart Of Certified Trading Education And Experience. Formal Multi-Faceted Trading Education process.

FIG. 5—Flow Chart Of Multi-Faceted Trading Education Forums And Type Of Topics.

### DETAILED DESCRIPTION OF THE INVENTION

### Principles of the Invention

The financial markets vary as how they recognize and reward market value creation. Many markets are based upon a traditional approach know over the ages of taking a position when demand is low or pricing is low and selling later as demand increases and presumably pricing increases. This is the buy and hold method of market participation. Under such market value creation operations, the Thick Line can reliably identify and signal a low demand market cycle, the end of a low priced market cycle, the emergence of an over-sold market cycle, and other market conditions predictive of anticipated market price increases. The principle of the invention is identifying immediately pending market price change conditions, in this case predictive of coming increases in market value.

Financial markets have evolved to include financial instruments and associated markets with less direct connection with physical value exchange and more associated with definitional, comparative, or situational value creation. Under such circumstances, if value creation is associated, value creation may occur with markets that increase in pricing, demand, or other factors or decrease in pricing, demand, or other factors.

In these markets, the Thick Line Indicator continues to reliably identify and signal up-market conditions from the end of a low demand market cycle, the end of a low priced market cycle, the emergence of an over-sold market cycle, and other market conditions predictive of anticipated market price increases. The Thick Line Indicator may assess just such conditions over various time periods and provide up-market or a market with generally increasing pricing for variously associated times and price change magnitudes.

As discussed within the financial instruments and associated markets there is recognized value creation with down-market pricing changes. What is meant as a down-market is the consistent trend of market pricing from one period to the next being generally lower than the previous. Normally this is associated with a loss in value, except in such markets as value can be create both when market price increases and when market price decreases. In this case, the Thick Line Indicator can similarly and reliably identify and signal down-market conditions from the end of a high demand market cycle, the end of a high priced market cycle, the emergence of an over-bought market cycle, and other market conditions predictive of anticipated market price decreases.

The principles of the invention are the recognized single Thick Line Indicator as being a leading or immediate market indicator of the change of market direction. The Thick Line results from the mathematical manipulation of market data to graphically and numerically represent financial market behavior. Disclosed is that combined with market pricing, the Thick Line provides a two-step criterion to create a tangible, concrete and reproducible, and useful signal to anticipate changes in market behavior for successful participation in the financial markets.

### DRAWING DESCRIPTION

The following drawings disclose the flow and manipulation of information and data then used to predict anticipated price movement to successfully participation in the financial markets.

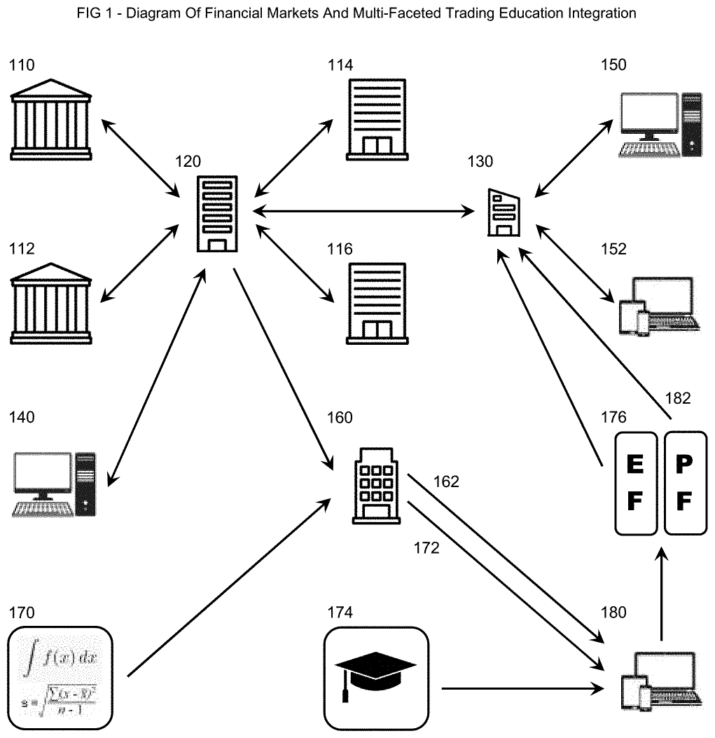

FIG. 1 is the Diagram Of Financial Markets And Multi-Faceted Trading Education Integration.

FIG. 1 shows there are various financial markets that have evolved from a local physical location based presence and influence to now a more global access model through information technology and connectivity. Today, these various markets would share a generally common structure to provide market access to institutional and individual investors and traders, we will call institutional or individual participants or participants. Describing this general market structure would include Major Private Financial Institutions 110 that provide capital or capital assurances to form the financial liquidity in the markets. Their individual influence varies based upon their involvement in a particular market or markets, generally recognized significance by governments, industry, the markets, and others. In cases they can influence market value, specific instrument value and pricing, and other market specific elements. Other Major Public Participants 112 such as governments and regulatory agencies, industry associations and monitors, media and social forces, and like influences also contribute to the market. They can participate in the market by providing offerings, financing, interest rate and other market leverage, regulation and policy, and more. The Private Markets 114 represent aggregators of specific market assets and instruments and set the general policies and procedures for participation in their market. They have direct and substantial influence upon the operation of the market and other influences. These institutions provide the interface between the financial markets and the physical world and industry. Naturally, the influences of this physical world such as supply and demand, technology, services, natural influence such as weather, and more provide direct influence on the existence and behavior of the markets. There are Public Markets 116 administered by governments and agencies. They may be less speculative in their structure, but they do operate to make assets and instruments available to market participants. In times past and in rare occasions today, the markets were location based. Today, the vast majority of markets are online based. Market Connectivity 120 is the result of market specific and general connectivity infrastructure of servers, connections, protocols, and more with the financial markets, brokers, end users, and their combinations. In this diagram Market Connectivity 120 is represented as a single entity, but it should be interpreted that in is present and connecting all other diagram elements. It is simply redundant to represent such a fundamentally understood element to the financial market structure and this disclosure diagram. Represented is that Major Private Financial Institutions 110, Major Public Interests 112, Private Markets, and Public Markets interact cooperatively and competitively in a manner as to create the functioning markets. Needed are participants in the markets. They take the form of Major Self-Brokering Participants 140 that have direct access to the market based upon the volume of their participation, other contributions to the market, and other factors. Again, they participate in the market directly through their own market access. Given the characteristics of their participation in the markets, they can have an influence upon market behavior. The vast majority of market participants do so through a market intermediary or Broker 130. The Broker 130 facilitates market participation for lower volume Institutional Participants 150 and Individual Participants 152. Institutional Participants 150 represent large banks and financial institutions, endowments and funds, corporations and organizations, and individuals with equivalent resources that participate in the markets. They are not so involved in the markets as to participate as a Major Self-Brokering Participant, but their participation can have an impact on market behavior. The Broker 130 also services Individual Participants 152. This represents those with less volume participation and require and benefit from the services of a broker to access the markets. Their individual participation usually does not have an influence upon the market, but at times with sufficient collective sentiment, they can influence the market to some degree. They are to some degree sources of capital to the markets. This disclosure is not directed towards this generalized market structure discussed for reference and context. Further, other entities undoubtedly could be listed with a more granular discussion of the markets, but these key elements are sufficient to establish the connection of this disclosure to the markets.

FIG. 1 further discloses the use of a Market Data Manipulator 160 that receives market data and manipulates it to create tools and techniques to provide users the ability to analyze the markets to take position and participate in the markets. A Major Self-Brokering Participant 140, a Broker 130, an Institutional Participant 150, and an Individual Participant 152 may use their own methods of data manipulation or use an outside resource such as a Market Data Manipulator 160 to provide tools and techniques to better assess and participate in the markets. Such is the case with this disclosure. A Market Data Manipulator 160 is used for their Market Data and Analysis Software 162 that provides charted market data and analysis tools. A Market Data Manipulator 160 with the capacity to accept general or even the Applicant's mathematical algorithms 170 is used to create Trade Indicators 172 to assess historical, current, and anticipated market behavior. The combination of Market Data and Analysis Software 162 and Trade Indicators 172 provides a uniquely accurate assessment of anticipated market behavior are used by an Applicant Group Member 180 to identify market positions and participation that are then placed with a chosen Broker 130. The Applicant Group Member 180 can participate in the markets through the Broker 130 using an Applicant Trading Educational Real Money Account 176 or the Applicant Member's Private Trade Fund 182. What is disclosed is the use of the Trade Indicators 172 with Applicant Trading Education 174 and Applicant Trading Education Real Money Account 176 through appropriate connectivity to the market as previously discussed herein to facilitate the Applicant Group Member 180 to day trade the markets with surprisingly successful results.

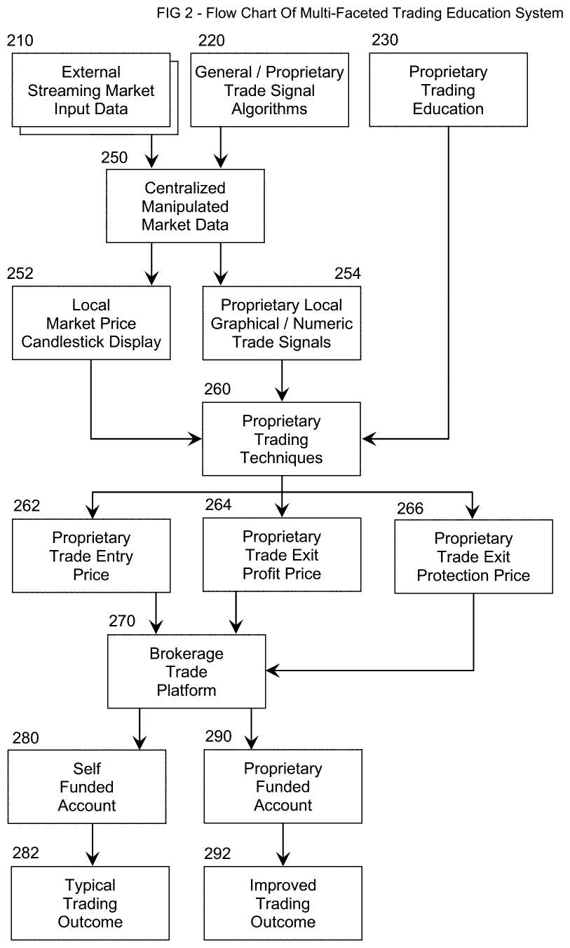

FIG. 2 is the Flow Chart Of Multi-Faceted Trading Education System.

FIG. 2 was previously and generally disclosed as Applicant Trading Education FIG. 1 172. Here the Applicant's Trading System of FIG. 1 172 is discussed in detail as the subject of this disclosure. For contrast, FIG. 2 briefly illustrates that the typical path of participation in the market for most Individual Participants FIG. 1 150 takes the form of interfacing with a Brokerage Trade Platform 270 online using a Private Self-Funded Account 280 and results in a Typical Trading Outcome 282. A typical result refers to what a person having ordinary skill in the art of market participation. That person is not referring to those professionally trained and participating in the markets with an institution account and institutional level of market awareness and advantage. The person of ordinary skill in the art is the individual who is self-trained, trained by an acquaintance, or has trained with a relevant service provider and is participating in the market as a lay, amateur, or non-professional. The Typical Trading Outcome 282 of this market participant is not widely successful and has led to a social perspective about financial market participation as being risky, not successful, that a few can profit while many will lose money, and so on. So prevalent is this perspective that governments and their agencies require disclosure of caution and warning. These may include such statements as “previous results are not indictive of future results,” “market participation is risky and is not right for all,” and so on. What is disclosed is a system of Trade indicators here identified as Local Graphical/Numeric Proprietary Signals 254 and Proprietary Trade Education 260 while using either a Self-Funded Account 280 or a Proprietary Real Money Education Fund 290 will result in surprisingly uncommon successful participation in the financial markets.

FIG. 2 reviewed in detail starts with a simplified representation of the financial markets as specifically interfacing with the Applicant's Multi-Faceted Trading Education System including key elements of General And/Or Proprietary Trade Signal Algorithms 220, Proprietary Trade Education 230, and Proprietary Real Money Trading 240. This figure uses the term “Trade” throughout. The term “Trade” takes upon it the usual meaning of participating in the financial markets. More specifically referring to a participation on a shorter-term basis that may be for minutes, hours, days, and weeks. In this disclosure “Trade” is also encompassing of what is inclusive of the term “Investing.” Where “Investing” has a definition and understanding to represent more of a longer-term participation in the markets of months to years. Again, “Trading” is intended to be inclusive of all and any form of participation in the financial markets and for any and all financial markets. Proprietary Trade Signal Algorithms 220 refers to mathematical equations. External Streaming Market Input Data 110 is representative of the totality of FIG. 1 110, 112, 114, 116, and 120, and related players and infrastructure from which various sources arrives to the Centralized Manipulated Market Data 250 provider also represented in FIG. 1 160. The Centralized Manipulated Market Data 250 provider also accepts the General And/Or Proprietary Trade Signal Algorithms 220 as also represented by FIG. 1 170. The result is both typical market data in the form of Local Market Price Candlestick Display 252 and as shown by FIG. 1 162 and associated charting and tools, but also Local Graphical and Numeric Proprietary Signals 254 and as shown by FIG. 1 172. The term local represents that data, connectivity, and data manipulation occurring elsewhere in the market structure are provided by online connectivity to an Individual Participant FIG. 1 152 or even to an Institutional Participant FIG. 1 150 at their location or on their personal computer or trade station. The culmination of the generic Local market Price Candlestick Display 252 data, Proprietary Local Graphical and Numeric Trade Signals 254, along with specific related education from Proprietary Trading Education 230 results in Proprietary Trading Techniques 260. The specific outcomes are the Proprietary Trade Entry Price 262 determination, the Proprietary Trade Exit Profit Price position 264, and the Proprietary Trade Exit Protection 266 position to constitute a complete and highly anticipatory trade with regard to expected market direction and magnitude movement. The individual or institutional market participant then receives the Applicant's Proprietary Trading Techniques 260 enhanced by Applicant Proprietary Trade Education 230 as also represented in FIG. 1 174 and through their computer 270 and as detailed in FIG. 1 180 use a Brokerage Trade Platform 270 and as shown in FIG. 1 130 that facilitates a Proprietary Real Money Educational Fund 240 and 290 and as shown in FIG. 1 176 or a Self Funded Account 280 and a shown in FIG. 1 182 to execute trades and participate in the markets. The combination of General And/Or Proprietary Trade Signal Algorithms 220 in the useable form of Local Graphical and Numeric Proprietary Signals 254 to create Applicant Proprietary Trading Techniques 260 when catalyzed with understanding and best practices by Applicant proprietary Trade Education 230 are used as a system for Improved Trading Outcome 292. The Improved Trading Outcome 292 results from surprisingly accurate anticipated financial market direction and magnitude movement as a trade declaration of market entry price, market exit profit price, and market exit stop loss price. Improved Trading Outcomes 292 represents outcome greater than that of Typical Trading Outcomes 282. Again, the Typical Trading Outcomes 282 are representative of essentially a barely succeeding outcome that has resulted in a societal perspective of trading as being acknowledge as possible and profitable for some, but likely a losing situation for most. That places Improved Trading Outcomes 292 as more successful than the Typical Trading Outcome 282 as measured by Applicant Group Members being agreeable to paying a monthly subscription to day trade the Applicant's Multi-Faceted Trading Education System. If the outcomes were typical, a participant is typically barely sustaining themselves in the market. They may be winning here and there and losing about the same here and there. It is commonly recognized by persons of ordinary skill in the art of trading that a typical winning rate in the markets is about 65%. A win rate that is barely better than a guess and keeps the typical participant about even in wins and losses by the time there is consideration of their lack of confidence to do more for better results, considering trading costs, and so on. Validation that the Applicant's system produces an Improved Trading Outcome 292 is manifest by participants being willing to pay an access expense of a few hundred dollar monthly subscription, then there would be no participation as the cost of the system would not be justified by marginal trade results. Given Improved Trading Outcomes 292, such Applicant Multi-Faceted Trading Education System is justified from month to month. The Proprietary Trading Education 230, Proprietary Trading Techniques 260, Proprietary Trade Entry Price 262, Proprietary Trade Exit Profit Price 264, and Proprietary Trade Exit Protection Price 266 are specific actions or outcomes of the Proprietary Trade Signal Algorithms 220.

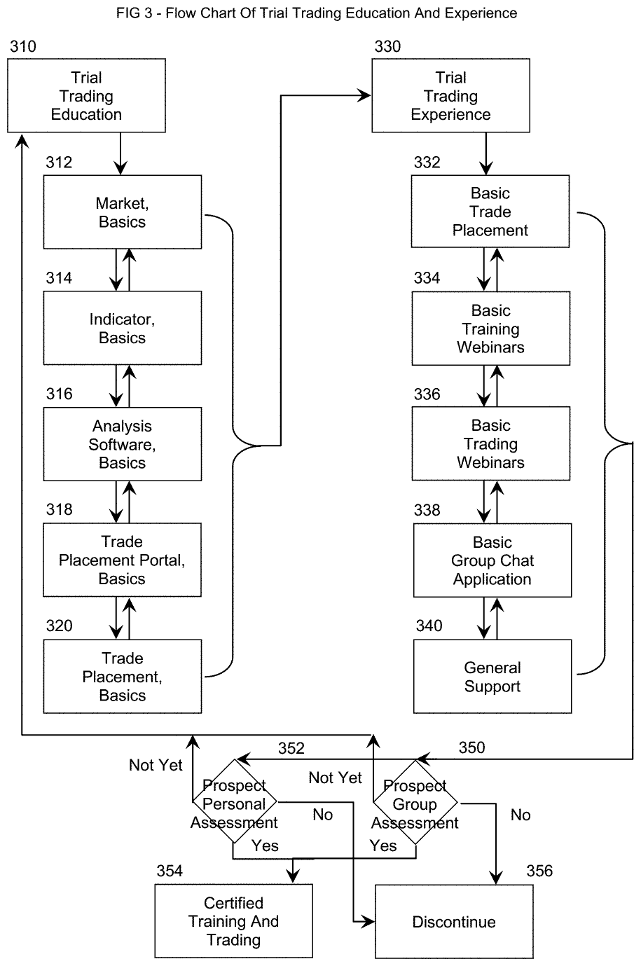

FIG. 3 is the Flow Chart Of Trial Trading Education And Experience.

FIG. 3 discloses the Applicant's proprietary Trial Trading Education And Experience method. A part of that Proprietary Trading Educational FIG. 2 230 system is a demonstration trial disclosed in FIG. 3 to assess a person's ability and interest in trading once they have experienced it. Their skill and emotional ability to participate in the financial markets is an important consideration. This Trial Trading Education And Experience starts with Personalized Trial Trading Education 310. The term “Personalized” continues with the common meaning that the training in whole or part contains a live personal interaction. This personalized interaction may be in a same location setting for a face-to-face interaction or by some form of remote connection using audio, visual, and technology related communication and work sharing. Important is that the Prospect is interacted with such that their specific needs, questions, and accomplishments can be addressed and acknowledged. As a best practice this involves 1-to-1 personal coaching and training for the best possible trading outcomes or Improved Trading Outcomes FIG. 1 292 and Proprietary Trading Outcome FIG. 1 294. This is a key element to the Proprietary Trading Education FIG. 1 230. There are five key elements of the Personalized Trial Trading Education 310 that are in largely the order of introduction, but as can be seen they are inter-related and a Prospect may emphasize one or the other more or less or before or after another as they need. A Prospect is a person who has entered the Multi-Faceted Trading Education process on a trial basis to assess their fit by skill and psychology capacity to continue in the greater process of trading. An earlier element of the Personalized Trial Trading Education 310 process is the Prospect learning Market Basics 312. This can include knowing the markets and selecting a market which also narrows brokerage firms available. It also includes: terminology, definitions, general market awareness, markets, trade times, and other relevant information to interact with the markets from a point of view of someone with ordinary skill in the art. Additionally, the Prospect is introduced to the Applicant's proprietary indicators with Indicator Basics 314. At a basic user level, this includes learning what they, their components, how those components react to the market, how indicator components anticipate coming market behavior, and how to interpret the indicators singly and in conjunction with other Applicant Proprietary Indicators FIG. 1 172 and FIG. 2 254. Analysis Software Basics 316 is having functional familiarity with currently used analysis systems. The basics of such an analysis system are used for implementing general best practices in this Trial Trading Education 310. Any trade system requires some access to the markets. Here it is represented by Trade Placement Portal Basics 318. This is the brokers trade portal as referred to in FIG. 1 130 and FIG. 2 270. The Trial Trading Education 310 includes the basic use of the broker trade portal. The culmination of the elements of the Trail Trade Education 310 is Trade Placement Basics 320 is inclusive of gaining the basic skills to apply a trade in the market. This combined with all other familiarity of the Trial Trading Education 310 process, the prospect can progress to the Trial Trading Experience 330.

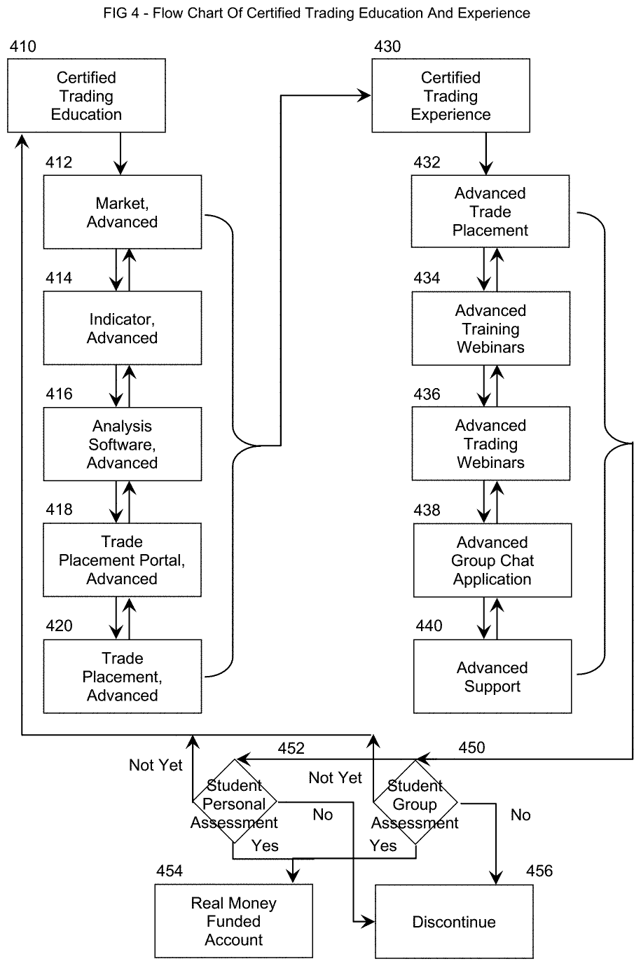

FIG. 3 discloses that additional educational process and reinforcing process of Trial Trading Experience 330. The Trial Trading Experience 330 differs from the Trial Trading Education 310 with an applied emphasis. That applied focus is observed with Basic Trade Placement 332 or the actual assessment, identification, and placement of a trade in the markets. This is the ultimate result desired by the Trial Trading Education and Experience process and is best learned by repetitive trading. In the trial process, there is an equal or substantial emphasis on not just winning trades, but becoming functionally familiar and smooth with identifying and placing trades. Complementing personal training aspects of the Trial Trading Education and Experience, there is the Basic Training Webinars 334 held regularly, even weekly or more. This is a training focused online and onsite group meeting that is more instructionally oriented than trade focuses. It is a significant compliment to the personalized training as it is likely another coach, training, or mentor presents the information and so there will be a potentially different perspective of basic information. The prospect also benefits from the questions and interactions of other attendees. In like manner the Basic Trading Webinar 336 is a compliment to the prospects more full trial awareness of trading and trade placement. This webinar is online and onsite with a focus on application of trade basics in identifying and placing trades. It also provides the prospect with the benefit of potentially additional perspective from other coaches, trainers, and mentors. Further, there is the benefit of insight from the interaction of other prospects. Additional contribution to the prospects Trial Trading Education and Experience is the Basic Group Chat Application 338 or Chat App. This electronic device application provides a way for prospects, members, coaches, and mentors to interact at the moment of interest. That is the moment that a trade questions arises, the moment of deciding on a trade or taking a trade. It provides additional opportunity for the prospect to internalize the principles and application of trading by connecting questions to real events. It also continues and broadens the discussion from many prospects, members, coaches, and mentors. The Basic Group Chat Application 338 is a key element to bringing personal and group training and trading alive as a functional skill. In addition to all that is available from the Trial Trading Education 310 and its elements and the Trial Trading Experience 330 a General Support 340 function is needed for other individual prospect requirements. Disclosed is that the Trial Trading Experience 330 element are inter-related and a prospect may emphasize one or the other in any order or simultaneously. The result of prospect Trial Trading Education 310 and Trial Trading Experience 330 is a cyclical or simultaneous assessment of a prospect's readiness for Certified Trading Education FIG. 4 410 and Certified Trading Experience FIG. 4 430.

FIG. 3 culminates with the Prospect Group Assessment 350 and Prospect Personal Assessment 352. Observed is that both assessments must operate cooperatively for the prospect to proceed to Certified Training And Trading 354. The Prospect Group Assessment 350 may result in a “Yes” determination that the prospect is ready for Certified Training And Trading 354 and in conjunction with the Prospect Personal Assessment 352, the prospect may proceed to Certified Training And Trading 354. Another assessment is a “Not Yet” ready to proceed. With this assessment the prospect would be redirected back to the Trial Trading Education 310 process in conjunction with Trial Trading Experience 310. After another cycle for simple reinforcement to a more full experience the prospect would be reassessed by the Group at the Prospect Group Assessment 350. A third determination is a “No” status. This means that the prospect is not ready to progress and will likely not achieve readiness and a recommendation would be suggested to discontinue the trial. Again, the Prospect Group Assessment 350 does not operate independently, but in conjunction with the Prospect Personal Assessment 352. This is the prospect making their own self-assessment of their readiness to proceed to Certified Training And Trading 354. The same assessments apply here. One may be that “Yes” the prospect feels ready to proceed to Certified Training And Trading 354 and may do so with the Prospect Group Assessment 350 determining the same “Yes” readiness status. Another, “Not Yet” ready would have the prospect cycling back through the Trial Trading Education 310 and Trial Trading Experience 330 elements for targeted strengthening of shortcomings or a more full training and trading cycle followed by a reevaluation by the Prospect Group Assessment 350 and the Prospect Personal Assessment 352. A third “No” or will not likely achieve readiness, now a disinterest, or other reason to Discontinue 356 the Trial Trading Education And Experience of FIG. 3. What is disclosed by FIG. 3 is a comprehensive Trial Trading Education And Experience for a person with or without previous trading experience to assess their interest and capacity to trade successfully using the Applicant's Multi-Faceted Trading Education system before committing additional time, energy, and other resources to a more formal and Certified Training And Trading 354 undertaking. There is not a time frame ascribed to the trial, but a determined prospect complete by the prospects and the groups standards within a couple of weeks. Again, the Trial Trading Education And Experience FIG. 3 is not to create mastery, but simply to impart enough basics for a prospect to assess the viability of the Applicant's Multi-Faceted Trading Education and system, as well as assess their compatibility with the Applicant's culture and group. These assessments to continue to Certified Training And Trading 354 through basic trading familiarity and association are often accomplished in a matter of days to a couple of weeks.

FIG. 4 is the Flow Chart Of Certified Trading Education And Experience.

FIG. 4 further details the Proprietary Trading Educational FIG. 2 230 system. FIG. 4 closely mirrors that disclosed in FIG. 3 but with each topic moving into advanced subject content and application. The similarity discloses the comprehensive and thorough nature of the Trial Trading Education And Experience of FIG. 3 to fully inform or fully vet a prospects compatibility and fit with the Multi-Faceted Trading Education system. Advanced throughout FIG. 4 represents more context around the basic information and skills imparted as disclosed in FIG. 3 as well as additional skills and additional applied emphasis. A prospect that enters the Certified Trading Education And Experience FIG. 4 trading is referred to as a student. Market Advanced 412 includes all of Market Basics, FIG. 3 312, but further includes how to find market information and awareness of what influences the financial markets. It includes how to assess the how to find forces that may influence market behavior such as: general news and events, specific market news and events, seasonal and calendar, and other forces on the market. It includes advanced awareness of how to interpret the expected impact and direction of market influences on market behavior. Indicator Advanced 414 includes that of Indicator Basics FIG. 3 314 that as well as additional insight into what the indicators monitor and what influences indicator behavior. That is beyond indicator directional mechanics, but understanding behind such directional mechanics. It includes full indicator awareness and utilization as well as the simultaneous use of more than one indicator at more than one time period. The result is not a planar or two dimensional perspective of the market and its historical, current, and anticipated behavior, but a view with more depth and dimensions. The result is an Improved Trading Outcome FIG. 2 292. Analysis Software Advanced 416 goes beyond functional familiarity to make basic market, indicator, and trade assessments to a multiple analysis, multiple analysis tool, and multiple market assessment. Proper and advanced trading with the Applicant's system includes the use of Local Graphical and Numeric Proprietary Signals FIG. 2 254, Proprietary Trading Techniques FIG. 2 260 and the Analysis Software Advanced 416 tied together by Proprietary Trade Education FIG. 2 230 and other factors, to include additional detail to be disclosed. Trade Placement Portal Advanced 418 again goes beyond simple mechanics of do-this/do-that to a level of understanding in the realm of why-do-this/why-do-that to full participation in the financial markets. With the totality of the Certified Trading Education 410 and its elements, the student is prepared for Trade Placement Advanced 420. This is the collective advanced education with final trade placement elements to confidently analyze the financial market, find suitable trades, and place those trades in the market for successful market participation.

FIG. 4 additionally discloses that the Certified Trading Education 410 is reinforced by experiential application with Certified Trading Experience 430. The first element is going from an informational emphasis to an applied emphasis with Advanced Trade Placement 432. This involves incorporating what was developed with the Certified Trading Education 410 and actually placing trades in the financial markets with a practice account. The practical application is reinforced by online Advanced Training Webinars 434 held regularly, even weekly or more. It provides the same breath to the Certified Trading Experience 430 as disclosed with the Trial Trading Experience FIG. 3 330 with different delivery perspective other student questions and related discussion, and such that results from a group context. The focus of this webinar is advanced training. A complement to this webinar is the online that may be in conjunction with an online Advanced Trading Webinars 436 with an applied trading emphasis. Here an advanced coach, trainer, or mentor demonstrates and discusses the full process of financial market fundamental analysis, technical analysis, trade identification and selection, trade placement, and trade exit strategies. Student are able to follow with the trading webinar to experience not simply a discussion, but an involved and applied experience. The scope and benefits described with the Basic Trading Webinar FIG. 3 336 are also present with the Advanced Trading Webinar 436, but emphasizing advanced Certified Trading Education 410 content and other elements of the Certified Trading Experience 430. A component of the advanced curriculum is the advanced knowledge and experience of the students in the Certified Trading Education and Experience FIG. 4 process. Compared to a seasoned trader, the student's skill still remains rudimentary at this point, but is substantially beyond that of the prospect in the Trial Trading Education And Experience FIG. 3 process. As such, the Advanced Group Chat Application 438 involves substantially more substantive and specific trade questions and discussions. Students the learn much more from each other and the responses of coaches, trainers, and mentors. Here, the coaches, trainers, and mentors may also respond more thoroughly. This creates an excellent learning environment for the students in the Certified Trading Education and Experience FIG. 4 process that adds significantly to their trade skill and capability development. The last of the key elements of the Certified Trading Experience 430 is the Advanced Support 440. This is inclusive of any basic support needed, but also encompasses specific coaching styles and preferences, more depth in software support, and more. In total the combination of Certified Trading Education 410 and Certified Trading Experience 430 results in a student having a sufficient foundation for emerging confidence in successful and improved market participation or Improved Trading Outcome 292.

FIG. 4 provides for a formal assessment process of the sufficient knowledge, practice, and confidence of the student to trade an Applicant's Proprietary Real Money Educational Fund 454. The assessment is similar to that of the Trial Trading Education And Experience FIG. 3 Prospect Group Assessment FIG. 3 350 and Prospect Personal Assessment FIG. 3 352. In the Certified Trading Education And Experience FIG. 4 process the student is assess by the Student Group Assessment 450. In this case the Group will consider not simply advance understanding, knowledge, and trade demonstration, but other factors of appropriateness to trade a Real Money Funded Account 454. The Group may assess that “Yes” the student is prepared for a real money fund. As seen, that is the first of the joint agreement before trading a Real Money Funded Account 454. The Student Group Assessment 450 may determine the student is “Not yet” ready for the Proprietary Real Money Educational Fund 454. As such, the student cycles through the Certified Trading Education 410 and the Certified Trading Experience 430 for specific trading refinement or a more holistic process approach and when appropriate be reassessed for a Real Money Funded Account 454. The Student Group Assessment 450 may also determine that the student should Discontinue 456 the Certified Trading Education And Experience FIG. 4 process. A companion assessment to the Student Group Assessment 450 is the Student Personal Assessment 452. It would be inappropriate to move a student into a Real Money Funded Account 454 if the student did not feel themselves ready for that fund. As such, the Student personal Assessment 452 has the student assessing just that. With a “Yes” personal assessment combined with the Student Group Assessment 450 with a “Yes” then the student can be established with a Real Money Funded Account 454. The student may assess themselves as “Not yet” ready for the real money fund and reenter the Certified Trading Education 410 and Certified Trading Experience 430 process for specific refinement or for a more holistic outcome as previously described. The student would then be reassessed when appropriate by the Student Group Assessment 450 and their Student Personal Assessment 452. A student could also determine after the Trial process and after the Certified Trading Education And Experience FIG. 4 that trading is not something of interest or not within their ability, they can determine to Discontinue 456. That would remove the student from the Certified Trading Education And Experience FIG. 4 process. No time frame is ascribed to the Certified Trading Education And Experience FIG process, but it often takes a matter of weeks for a student and the group to assess a student's readiness for a Real Money Funded Account 454

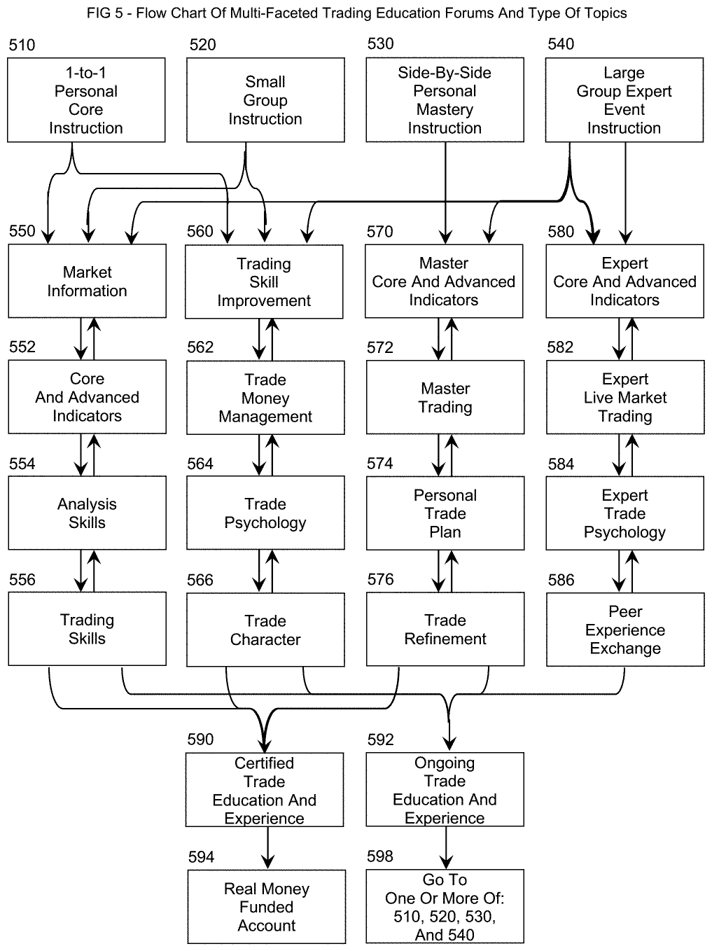

FIG. 5 is the Flow Chart Of Multi-Faceted Trading Education Forums And type Of Topics.

FIG. 5 discloses the multi-faceted nature of the Applicant's trading system encompassed in the Proprietary Trading Education FIG. 2 230. FIG. 5 more expressly defines the Proprietary Trading Techniques FIG. 2 260 which is the unique resulting combination of typical Local Market Price Candlestick Display FIG. 2 252 with Local Graphical and Numeric Proprietary Signals FIG. 2 254 and made effective by Proprietary Trading Education FIG. 2 230 to produce Improved Trading Outcome FIG. 2 281 beyond the Typical Trading Outcomes FIG. 2 282. The content of the education and the associated acts of trading or the experience support of the education have been outlined from a basic level with the Trial Trading Education And Experience FIG. 3 process and then the advanced Certified Trading Education And Experience FIG. 4 process. The assimilation of the Applicant's disclosed proprietary trading system with the financial markets is observed with the Diagram Of Financial Markets And Multi-Faceted Trading Education Integration FIG. 1 and in process form with the Flow Chart Of Multi-Faceted Trading Education System FIG. 2. The result is a student or new day trader having the capacity to trade in the financial markets with Improved Trading Outcomes FIG. 2 292. In addition to what has been disclosed, The Applicant's trading system is expressly multi-facetted by trading education forums and type of topics. Disclosed is an extensive array of educational and experiential elements from 1-to-1 Personal Core Instruction 510, Small Group Instruction 520, Side-by-Side Advanced Instruction 530, and Large Group Event Instruction 540. The inter-related and combined experience providing the student with multiple avenues of education by topic; multiple avenues of education by perspective with more than one and typically numerous different coaches, trainers, and mentors; multiple avenues of format from personal online and onsite, small group online and onsite, large group online and onsite, open chat forums, other forums a person of ordinary skill in the art would deduce from this Multi-Faceted Trading Education Forums And Type Of Topics FIG. 5. An important element of the Applicants Multi-Faceted Trading Education is that elements of the process are inter-related and a prospect, student, member, coach, and any participant may move from one element to the other within the associated elements. Created is a dynamic trade education and experience system that allows a participant to gain awareness of the whole of the system where needed, a specific element of the system and process, or focus on any one or more of the systems elements and process as is individually needed and desired. This dynamic and multi-faceted educational and experiential process is what creates the Improved Trade Outcomes FIG. 2 292 and an innovative spark of this disclosure.

FIG. 5 discloses the use of 1-to-1 Personal Core Instruction seen to encompass trade education and trade experience elements. This is inclusive of what was disclosed in the Certified Trading Education And Experience FIG. 4 process, but simply expressed alternatively. Market Information 550 is also included as knowing the different markets, what typically influences them, where to find information about those influences, how to anticipate the reaction of the market based on known influences, knowing the pace of the market, understanding the cyclical nature of the pricing, and other market awareness known and used by trader of ordinary skill in the art of trading. Initial and continued development of Core Indicators 552 includes awareness of general or Applicant's proprietary indicators, their components, how to use them, how to interpret them, and how to apply them for improved trading outcomes. The Core And Advanced Indicators 552 and Analysis Skills 554 were first introduced in a fundamental approach with the basic Trial Trading Education FIG. 3 310 and in an advanced manner with the Certified Trading Education FIG. 4 410. The nature of this training and education is that previously disclosed. Trading Skills 556 is the education that assembles knowledge gained and relates it to the trade placement process as previously discussed in the basic Trial Trading Education FIG. 3 330 and advanced Certified Trading Education FIG. 4 430 and represented here alternatively.

FIG. 5 discloses further advantages of the Multi-Faceted Trading Education system and process of the Applicant. What follows from a formalized education and experiential curriculum are an internalization of the trade process to begin to recognize trading as one's own or coming from oneself and not simply information and mechanics being more step-wise executed. Those attributes begin to emerge with Trading Skill Improvement 560. This emerges with practice and live trading over time and with reiterative education, coaching, and introspection by the trader about their trading. More education follows on advanced subjects of proper Trade Money Management 562. Not only is knowing the current fundamental character of the market, knowing how to analyze market data assess the current technical character of the market for potential trades, and then placing trades in the market, such trades must be applied with proper money management from trade entry to trade exit. This can include proper trade size, number of trades, projected distance the market will move, recovery methods for trades that may go against the trade setup, and more. Many of ordinary skill in the art would assert that money management or trade management may be some of the most important considerations of trade success. As such, the Applicant amply includes such information and training into the Multi-Faceted Trading Education process. A topic in the Applicant's trade curriculum, but difficult to instill, except through live market experience is that of Trade Psychology 564. This represents the necessity of proper trading attributes of the trader to participate in the market. This would be personal attributes such as patience for a better trade opportunity to present itself, rather than accepting a less than favorable trade simply because the trader is impatient, pressed for time, is eager to trade or place multiple trades, and so on. It represents the trader's ability to be disciplined to follow proven or establish general or personal trade plans and protocols that have been tested and proven successful generally or for the particular trader. It is disciplined to trade for a certain number of trades, a certain number amount of movement in the market, a certain amount of time, a certain amount of profit, and so forth and then be done with trading. Finish trading before fatigue, greed, poor discipline, and other failures in trade psychology begin to emerge with time in the market. As with Trade Money Management 562, Trade Psychology 564 can be considered some of the most important contributors to a successful trade routine and is a major contributor to the Applicant's Improved Trading Outcomes FIG. 2 292. Here it is addressed the in Applicant's Multi-Faceted Trading Education system and process. Also included in the Applicant's system and process is Trade Character 566 considerations. Not every market behaves the same. Not every asset or instrument within the same market behaves the same. Not every trade setup on an asset or instrument behaves the same, and so on. To address the additional variability of trading knowledge of Trade Character 566 is paramount. The Applicant's system and process addresses this important consideration on topics herein just mentioned, among others known to persons of ordinary skill in the art to again create the Improved Trading Outcomes FIG. 2 292 of which is specifically sought and designed. The result of the 1-to-1 Personal Core Instruction 510 is the student gaining or completing a Certified Trading Education And Experience 590 that leads to a Real Money Funded Account 594, which is the primary purpose of the Applicants Multi-Faceted Trading Education process. Another outcome of the 1-to-1 Personal Core Instruction 510 contribution is continued or Ongoing Trade Education And Experience 592 by simply returning to 1-to-1 Personal Core Instruction 510, more Small Group Instruction 520, higher level instruction with Side-By-Side Personal mastery Instruction 530 and Large Group Expert Event Instruction 540. Actually, ordinary people skilled in the art would recognize that continued and deliberate education and experience training should not end but always be a part of successful financial market trade participation.

FIG. 5 discloses that the educationally based elements numbered 550 to 556 and experientially based elements numbered 560 to 566 just discussed are introduced by 1-to-1 Personal Core Instruction 510. These same just immediately presented educationally based elements numbered 550 to 556 and experientially based elements numbered 560 to 566 are further reinforced by Small Group Instruction 520. As disclosed previously the small group provides additional insight in the same subject matter, but often with a new or different perspective to the student given the subject is likely to be presented by a different coach, trainer, or mentor. Given the different instructor or presenter, there may even be some new information imparted on topics already discussed with the student at a basic and advanced manner. Further, the small group dynamic allows for students to gain insight and perspective from the interaction of other students with instructors and other students. The Small Group Instruction 520 provide valued breadth to information and application of trading education and experience. As with the 1-to-1 Personal Core Instruction 510, the Small Group Instruction 520 ultimately results in the student progressing through or completing the Certified Trading Education And Experience 590 and beginning to a Real Money Funded Account 594. The outcome of the Small Group Instruction 520 can also be to simply continue with additional instruction and exposure as summarized with step 598 or Go to One Or More Of; 510, 520, 530, and 540.

FIG. 5 continues to disclose the Multi-Faceted Trading Education Forums And Type Of Topics incorporates Side-By-Side Personal Mastery Instruction 530. That which has been disclosed herein to this point can be instruction given online or onsite. The majority of the instruction being given online. It would be undisputed that for subject mastery having the student and the coach, trainer, or mentor together personally would have many advantages. As such, the Applicant's system and process includes educational and experiential components given in person. Not just 1-to-1 personal, but side-by-side and personally. Note that personally may not mean only one student with one coach, trainer, or mentor although that is often the case. It absolutely means no more than a handful so as to retain a personal awareness of the coach, trainer, or mentor to the student. Undoubtedly more than one student could constitute a small group, but small group is referred to as more than a handful but when the personal connection of the coach, trainer, or mentor is largely disconnected. Nevertheless, in at this time the Side-by-Side Personal Mastery Instruction has a focused curriculum. Including Master Core And Advanced Indicators 570. The Applicant has a suite of proprietary indicators derived from associated proprietary algorithms to manipulate financial market data. Here the student is taken beyond basic indicators and advanced training on all the indicators, but is provided instructional education and applied experience of general or the Applicant's proprietary indicators at a level of mastery. Mastery meaning further insight into the interaction of the indicators with financial market data, mastery with the indicators themselves, mastery with interpretation of the indicators to anticipate market behavior, and more. Mastery includes fluency and fluidity with the indicators such that the student is beyond laboring over mechanics of application and into having the indicators become a useful tool. This manifests itself in Master Trading 572 that is demonstrated by Improved Trading Outcomes FIG. 2 292, as previously defined. Given the additional time and in-person nature of the Side-By-Side Personal Mastery Instruction 530, a benefit is the development of a Personal Trade Plan 574. This elevates the student's confidence and success in the market knowing their instruction includes the specific tailoring of the Applicant's Multi-Faceted Trading Education system and process to them personally. That means adapted to their level of tolerance for market risk, their need for market gain or modulating their sense of greed in the market, the time they have, the hours of the day or week they have to trade, the frequency they like to trade, the number of trades at one time they seem to prefer or that is wise for the account, as well as dialing in money management, and other such topics as included in the Applicant's educational and experiential process. A student before this point is adapting their trading based upon the Applicant's educational and experiential system and process, but such evolution is less deliberate and finely refined as is available with master Side-By-Side Personal Mastery Instruction 530. Ultimately, the student expresses an increased trading skill and capacity through Trade Refinement 576, again for Improved Trading Outcomes FIG. 2 292 as previously elaborated. As with other facets of the Applicant's trading education the Side-By-Side Personal Mastery Instruction 530 culminates with the student more confidently progressing through or completing their Certified Trading Education And Experience 590 leading to trading a Real Money Funded Account 594. Additionally, a student of this level of involvement and mastery of the Applicant's Multi-Faceted Trading Education FIG. 5 will expectedly also participate in Ongoing Trade Education And Experience 592 in a variety of ways to include elements 598 of Going To One Or More Of: 510, 520, 530, and 540 of the Applicants educational process and system. Persons of ordinary skill in the art, and especially those of mastery realize the importance of continued trade skill and capacity development.

FIG. 5 additionally discloses the Applicant's Multi-Faceted Trading Education Forums And Type Of Topics includes Large Group Expert Event Instruction 540. Observed is that the breadth of the Large Group Expert Event Instruction 540 could incorporate and address all and any aspect of the Applicant's Multi-Faceted Trading Education system and process. Large group events are those that go beyond a small group event. A small group event is at a participant number where the coach, trainer, presenter, or mentor is not dealing on a personal level with the participants, but is aware of and can acknowledge individuals. These can be online or onsite events. The large group events are those that have the coach, trainer, presenter, or mentor speaking generally to a crowd. Individuals are engaged, but there is not an intent to know or retain a recognition of an individual. These large group events provide for an expert instructional environment as the Applicant can draw from its best resources in instructional talent, topic, timing, and so forth to have the greatest instructional impact. Often this instruction is more lecture oriented with oral and visual components, but it is not intended that the student or member follow along with their analysis software and trades at that moment. However, many students and members do bring devices to the large group events online or onsite and do meticulously follow the instruction at the moment. Of course, this is to their advantage. The Large Group Expert Event Instruction 540 allows all students and members access to the best instruction and elements at the moment of the Applicant's trading educational system and process and adds greatly to the expertise of the participants. If a student or member of the group needs reinforcement of a Large Group Expert Event Instruction, they are always able to cycle back through any layer of the Applicant's Multiple Layer Trading Education process to gain the clarity and applied skill ability they seek. Often the students and members participating in the Large Group Expert Event Instruction are already participating in the market with a practice and even a real money account and so they often readily recognize the expert topics and elements of those topics based on their own growing trade experience. The subjects are not limited, but can include Expert Core And Advanced Indicators 580 from the Applicant's top coaches, trainers, mentors, and even more experienced members for the most effective and expert instruction. Expert Live Market trading 584 from the Applicant's pool of most successful live market traders to impart their insight, techniques, and tips for expert market outcomes. These may be the Applicant's coaches, trainers, mentors, or even more experienced members. Expert Trade Psychology 586 refers to the steadiness by which a student or member interacts with the market to avoid trading errors brought about by emotion, greed, impatience, poor trade management, inconsistency, and other such personal aspects of trading. Inclusive of some of the most important aspects of live financial market trading, addressing trade psychology with system and Applicant experts is a critical element to profitable trade success. That expertise is achieved, by the Applicant drawing on the group's best coaches, trainers, mentors, and members that demonstrate expert trading based upon their knowledge and mastery of applying personal psychology to successful trading. Without Large Group Expert Event Instruction 540, a presentation from such experts may not otherwise be available to the entire student and membership. As with the chat application and smaller group forums that allow for student interaction, the Peer Experience Exchange 586 in the Large Group Expert Event Instruction 540 provides an expanded and refined interaction. Here students and members benefit from interaction with the most experienced and most successful group members. Given that interaction is with the Applicant's most expert coaches, trainers, and mentors, as well as most seasoned and successful members this forum provides students and other members access to rare expertise based on education and experience. The combination of elements of the Large Group Expert Event Instruction 540 clearly contribute to Improved Trading Outcomes FIG. 2 292 specifically designed and innovated by the Applicant's Multi-Faceted Trading Education of this disclosure. Like other aspects of the Applicants system and process the outcomes are more confident day traders continuing or completing Certified Trading Education And Experience 590 leading to or continuing with a Real Money Funded Account 594. The ultimate goal is the student confidently and successfully trading their privately funded account with Improved Trading Outcomes FIG. 2 292. As discussed throughout, the learning, education, and expanded experience does not end with successful day traders and those seeking success. As such and again, another outcome of the Large Group Expert Event Instruction is to additionally provide Ongoing Trade Education And Experience 592 by returning to any and all available topics as suggested by 598 Go To One Or More Of: 510, 520, 530, and 540. The result of the Applicant's Multi-Faceted Trading Education Forum And Type Of Topics FIG. 5 is an Improved Trading Outcome of FIG. 2 292 as previously define.

While the invention has been described with particular reference to the preferred embodiments and with specific reference to the Forex Market, it will be understood by those skilled in the art that various changes may be made and equivalents may be substituted for elements of the preferred embodiments and based upon use with other financial markets without departing from the invention. It is accordingly intended that the claims shall cover all such modifications and applications that do not depart from the true spirit and scope of the invention.

1. The multi-faceted trading education method comprising:
the dispersed financial markets by infrastructure connectivity provides externally streamed financial market information,
the centralized manipulation market data center receives the externally streamed financial market information,
the centralized manipulation market data center receives the proprietary trade signal algorithms,
the centralized manipulated market data center manipulates the external streaming market input data with the proprietary trade signal algorithms to locally provide by market infrastructure connectivity user local graphical and numeric trade signals,
the centralized manipulated market data center manipulates the external streaming market input data to locally provide by market infrastructure connectivity user local market price candlestick display,
the user local graphical and numeric trade signal with the user local market price candlestick display and the proprietary day trading education create the proprietary trading techniques for the user to locally create specific anticipated financial market direction and magnitude movement,
the trader uses anticipated financial market direction and magnitude movement to set a local trade declaration of market entry price, market exit profit price, and market exit stop loss price,
The local trade declaration is transmitted by market infrastructure connectivity to the brokerage trade platform, and
the brokerage trade platform with a user funded account makes the local trade declaration with the financial market by market infrastructure connectivity.

2. The proprietary trading technique of claim 1 comprising a trial trading education of market basics, indicator basics, analysis software basics, trade placement portal basics, and trade placement basics along with a trial trading experience of basic trade placement, basic training webinars, basic trading webinars, basic group chat application, and general support.

3. The trial training and trading of claim 2 comprising a prospect's personal assessment and a prospect's group assessment to certified training and trading education.

4. The certified training and trading of claim 3 comprising a certified training education of advanced market analysis, advanced indicators, advanced software analysis, advanced trade placement portal, and advanced trade placement along with a certified trading experience of advanced trade placement, advanced training webinars, advanced trading webinars, advanced group chat application and advanced support.

5. The certified training and trading of claim 4 comprising a prospect's personal assessment and a prospect's group assessment to continue with a real money funded account.

6. The real money funded account of claim 5 comprising the funded account being a proprietary real money educational funded account.

7. The real money funded account of claim 5 comprising the funded account being a private real money self funded account.

8. The proprietary trading techniques of claim 1 comprising an upward buy financial market trade declaration.

9. The proprietary trading techniques of claim 1 comprising a downward sell financial market trade declaration.

10. The multi-faceted trading education method comprising:
the dispersed financial markets by infrastructure connectivity provides externally streamed financial market information,
the centralized manipulation market data center receives the externally streamed financial market information,
the centralized manipulation market data center receives the proprietary trade signal algorithms,
the centralized manipulated market data center manipulates the external streaming market input data with the proprietary trade signal algorithms to locally provide by market infrastructure connectivity user local graphical and numeric trade signals,
the centralized manipulated market data center manipulates the external streaming market input data to locally provide by market infrastructure connectivity user local market price candlestick display,
the user local graphical and numeric trade signal with the user local market price candlestick display and the proprietary day trading education create the proprietary trading techniques for the user to locally create specific anticipated financial market direction and magnitude movement,
the trader uses anticipated financial market direction and magnitude movement to set a local trade declaration of market entry price, market exit profit price, and market exit stop loss price,
the 1-to-1 personal core instruction,
the small group instruction,
the side-by-side personal mastery instruction,
the large group expert event instruction,
the culmination of certified trade education and experience for a real money funded account of, and
the ongoing trade education and experience.

11. The 1-to-1 personal core instruction of claim 1 comprising a trade education of market information, core and advanced indicators, analysis skills, and trading skills in addition to an experience of trading skill improvement, trade money management, trade psychology, and trade character contributing to ongoing trade education and experience and certified trade education and experience for real money funded account.

12. The small group instruction of claim 1 comprising an education of market information, core and advanced indicators, analysis skills, and trading skills in addition to an experience of trading skill improvement, trade money management, trade psychology, and trade character contributing to ongoing trade education and experience and certified trade education and experience for real money funded account.

13. The side-by-side personal mastery instruction of claim 1 comprising a trade education and experience of master core and advanced indicators, mater trading, personal trade plan, trade refinement contributing to ongoing trade education and experience and certified trade education and experience for real money funded account.

14. The Large group expert event instruction of claim 1 comprising an education and experience of expert core and advanced indicators, expert live market trading, expert trade psychology, peer experience exchange, as well as market information, core and advanced indicators, analysis skills, and trading skills, trading skill improvement, trade money management, trade psychology, trade character, master core and advanced indicators, master trading, personal trade plan, and trade refinement.
